(19) United States
(12) Patent Application Publication
(10) Pub. No.: US 2026/0313460 A1
(43) Pub. Date: Oct. 8, 2026

(54) METHODS FOR LOAD BALANCING CONTROL OF WIRELESS CONNECTION AND WIRELESS NETWORK SYSTEMS

(71) Applicant: Delta Electronics, Inc., Taoyuan (TW)

(72) Inventors: Yu-Wei LEE, Taoyuan (TW); Chi-Feng TANG, Taoyuan (TW); Kuei-Li HUANG, Taoyuan (TW)

(21) Appl. No.: 19/171,403

(22) Filed: Apr. 7, 2025

(51) Int. Cl. H04W 28/086; H04W 28/02

(52) U.S. Cl. CPC H04W 28/086; H04W 28/0231

(57) ABSTRACT

An embodiment method for load balancing control of wireless connection in an area is provided. The method comprises storing, by a controller, a heatmap representing values of at least one characteristic of signals received from the plurality of access points in subregions within the area. The method comprises monitoring loads of the plurality of access points. The method comprises selecting a first access point from the plurality of access points, wherein the first access point is determined to be overloaded. The method comprises receiving locations of a first plurality of client stations connected to the first access point. The method comprises selecting, by the controller, a first client station from the first plurality of client stations and a second access point from the plurality of access points by executing a load balancing algorithm based on the heatmap and the locations of the first plurality of client stations. The method comprises transmitting, by the controller, a handover message to the first client station through the first access point.

### BACKGROUND

### Field of the Invention

The present disclosure relates to wireless network systems, methods for load balancing control of wireless connection, and computer-readable medium for the same.

### Description of Related Art

A wireless local area networks (WLANs) typically includes a plurality of access points (APs) and serves multiple client devices. Generally, a client device would decide which access point to connect to. In high-density environments, the client device's choice to connect to one or another AP can lead to an AP overload. Under such circumstances, a wireless load balancing process may be required to distribute wireless traffic more efficiently among wireless access points and to improve user experience.

### SUMMARY

According to the present disclosure, a method for load balancing control of wireless connection in an area is provided. The method comprises storing, by a controller, a heatmap representing values of at least one characteristic of signals received from the plurality of access points in subregions within the area. The method comprises monitoring loads of the plurality of access points. The method comprises selecting a first access point from the plurality of access points, wherein the first access point is determined to be overloaded. The method comprises receiving locations of a first plurality of client stations connected to the first access point. The method comprises selecting, by the controller, a first client station from the first plurality of client stations and a second access point from the plurality of access points by executing a load balancing algorithm based on the heatmap and the locations of the first plurality of client stations. The method comprises transmitting, by the controller, a handover message to the first client station through the first access point.

In some embodiments, the at least one characteristic of signals includes at least one of signal strength, frequency, and interference.

In some embodiments, the method further comprises generating the heatmap based on one or more path loss models, area information, and access point information.

In some embodiments, the area information includes one or more of area layouts, wall information, and wall loss information of the area.

In some embodiments, the access point information includes access point location information, access point channel information, access point channel bandwidth information, or access point power information of one or more of the plurality of access points.

In some embodiments, the heatmap represents the values of the at least one characteristic of signals received from each of the plurality of access points in each of the subregions within the area.

In some embodiments, the method further comprises determining whether one of the plurality of access points is overloaded based on the loads of the plurality of access points.

In some embodiments, the heatmap represents values of signal strength of the signals received from the plurality of access points, and the selecting the first client station and the second access point comprises acquiring, from the heatmap and the locations of the first plurality of client stations, a plurality of first data sets each representing values of signal strength of the signals received from the plurality of access points by one of the first plurality of client stations and executing the load balancing algorithm based on the plurality of first data sets.

In some embodiments, the heatmap represents values of interference of the signals received from the plurality of access points, and the selecting the first client station and the second access point further comprises acquiring, from the heatmap and the locations of the first plurality of client stations, a plurality of second data sets each representing values of interference of the signals received from the plurality of access points by one of the first plurality of client stations and executing the load balancing algorithm based on the plurality of second data sets.

In some embodiments, selecting the first client station and the second access point by executing the load balancing algorithm further based on the loads of the plurality of access points.

In some embodiments, the method further comprises receiving a list of the first plurality of client stations.

In some embodiments, the receiving the locations of the first plurality of client stations comprises receiving the locations of the first plurality of client stations from a positioning unit.

In some embodiments, the method further comprises acquiring the locations of the first plurality of client stations by the positioning unit using ultra-wideband (UWB) positioning techniques, Wi-Fi positioning techniques, Bluetooth Low Energy (BLE) positioning techniques, or LiDAR positioning techniques.

In some embodiments, the method further comprises acquiring a location of one of the first plurality of client stations by the positioning unit by comparing a fingerprint information of the one of the first plurality of client stations to data in a fingerprint database.

According to the present disclosure, a wireless network system is provided. The wireless network system comprises a plurality of access points and a controller. The plurality of access points is configured to provide wireless connection in an area. The controller is communicatively connected with the plurality of access points. The controller comprises a heatmap unit, a load balancing unit, and a handover unit. The heatmap unit is configured to store a heatmap representing values of at least one characteristic of signals received from the plurality of access points in subregions within the area. The load balancing unit is configured to monitor loads of the plurality of access points. The load balancing unit is configured to select a first access point from the plurality of access points, wherein the first access point is determined to be overloaded. The load balancing unit is configured to receive locations of a first plurality of client stations connected to the first access point. The load balancing unit is configured to select a first client station from the first plurality of client stations and a second access point from the plurality of access points by executing a load balancing algorithm based on the heatmap and the locations of the first plurality of client stations. The handover unit is configured to transmit a handover message to the first client station through the first access point.

In some embodiments, the at least one characteristic of signals includes at least one of signal strength, frequency, and interference.

In some embodiments, the wireless network system further comprises a positioning unit configured to acquire the locations of the first plurality of client stations. The load balancing unit receives the locations of the first plurality of client stations from the positioning unit.

In some embodiments, the heatmap unit is configured to receive area information and access point information and generate the heatmap based on one or more path loss models, the area information, and the access point information.

In some embodiments, the heatmap represents the values of the at least one characteristic of signals received from each of the plurality of access points in each of the subregions within the area.

In some embodiments, the load balancing unit is configured to determine whether the plurality of access points is overloaded based on the loads of the plurality of access points.

According to the present disclosure, a computer-readable medium storing computer executable code for load balancing control of wireless connection in an area is provided. The code when executed by a processor of a controller cause the processor to store a heatmap representing values of at least one characteristic of signals received from the plurality of access points in subregions within the area. The code when executed by a processor of a controller cause the processor to monitor loads of the plurality of access points. The code when executed by a processor of a controller cause the processor to select a first access point from the plurality of access points, wherein the first access point is determined to be overloaded. The code when executed by a processor of a controller cause the processor to receive locations of a first plurality of client stations connected to the first access point. The code when executed by a processor of a controller cause the processor to select a first client station from the first plurality of client stations and a second access point from the plurality of access points by conducting a load balancing algorithm based on the heatmap and the locations of the first plurality of client stations. The code when executed by a processor of a controller cause the processor to transmit a handover message to the first client station through the first access point.

In some embodiments, the code when executed by a processor cause the processor to generate the heatmap based on one or more path loss models, area information, and access point information.

### BRIEF DESCRIPTION OF THE DRAWINGS

FIG. 1A is a schematic diagram of a wireless network system.

FIG. 1B is a schematic diagram of an exemplary frame of a client device connected to the wireless network system of FIG. 1A.

FIGS. 2A and 2B are schematic diagrams of a wireless network system according to one embodiment of the present disclosure.

FIG. 2C is a schematic diagram of a controller of the wireless network system shown in FIG. 2A according to one embodiment of the present disclosure.

FIGS. 3A and 3B illustrate an exemplary heatmap according to one embodiment of the present disclosure.

FIG. 3C illustrates an access point list for the heatmap shown in FIGS. 3A and 3B.

FIG. 4 is a flowchart illustrating a method for load balancing control of wireless connection in an area according to one embodiment of the present disclosure.

FIG. 5 is a schematic diagram of a positioning unit according to one embodiment of the present disclosure.

FIG. 6 is a schematic diagram of another positioning unit according to one embodiment of the present disclosure.

### DETAILED DESCRIPTION OF EMBODIMENTS

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. Description of the operation does not intend to limit the operation sequence. Any structures resulting from recombination of devices with equivalent effects are within the scope of the present disclosure. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

Furthermore, it should be understood that the terms, “comprising”, “including”, “having”, “containing”, “involving” and the like, used herein are open-ended, that is, including but not limited to. It will be understood that, as used herein, the phrase “and/or” includes any and all combinations of one or more of the associated listed items.

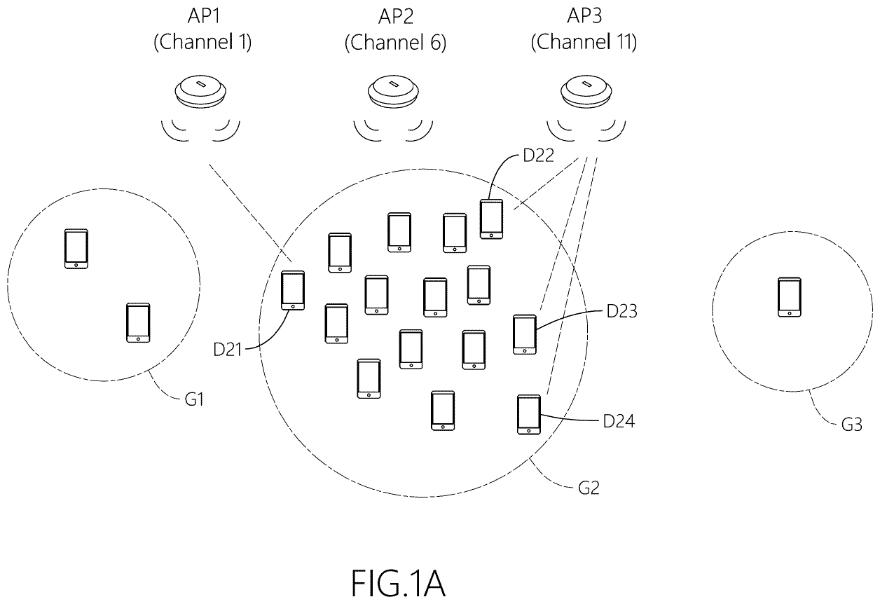

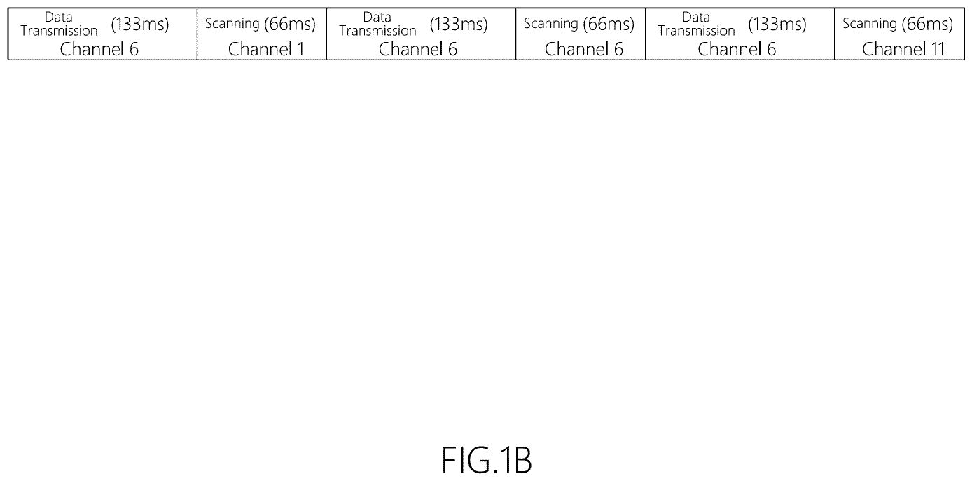

FIG. 1A is a schematic diagram of a wireless network system. FIG. 1B is a schematic diagram of an exemplary frame of a client device connected to the wireless network system of FIG. 1A. Referring to FIG. 1A, a plurality of client devices are connected to a wireless network system including multiple access points (APs), such as access points AP1, AP2, AP3. In the scenario shown in FIG. 1A, a large number of client devices (e.g., a second plurality of client devices G2) may be connected to the access point AP2 and may lead to access point overload, while less client devices (e.g., a first plurality of client devices G1) are connected to the access point AP1 and only one client device (e.g., the only one client device in a third plurality of client devices G3) is connected to the access point AP3. In such a scenario, some client devices in the second plurality of client devices G2 may need to roam to another AP for better quality of the connection. In order to determine a suitable AP to which the client device may roam now or in the future, the client device may need to constantly scan through channels. A client device may transmit a probe request and listen for a probe response from an AP; or a client device may listen on each channel for beacons sent periodically by an AP. For example, client device D21 may detect signal strength from the access point AP1 through scanning process and roam to access point AP1 based on the detection results. Similarly, client devices D22, D23, and D24 may each detect signal strength from the access point AP3 through scanning process and roam to access point AP3 based on the detection results. As shown in FIG. 1B, a client device, such as client devices D21, D22, D23, and D24, may spend one third of the time for such a scanning process. This may reduce transmission rate and may consume resources of the client device.

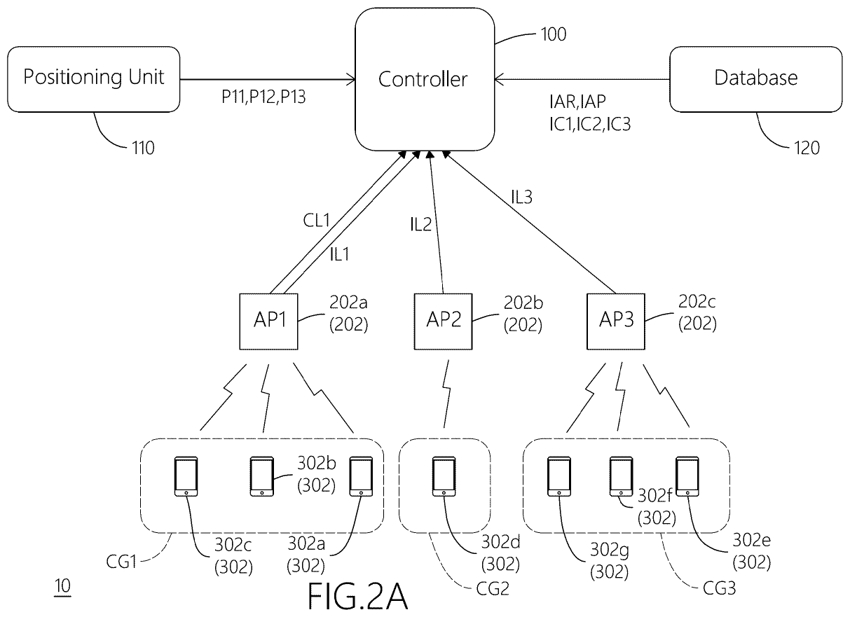

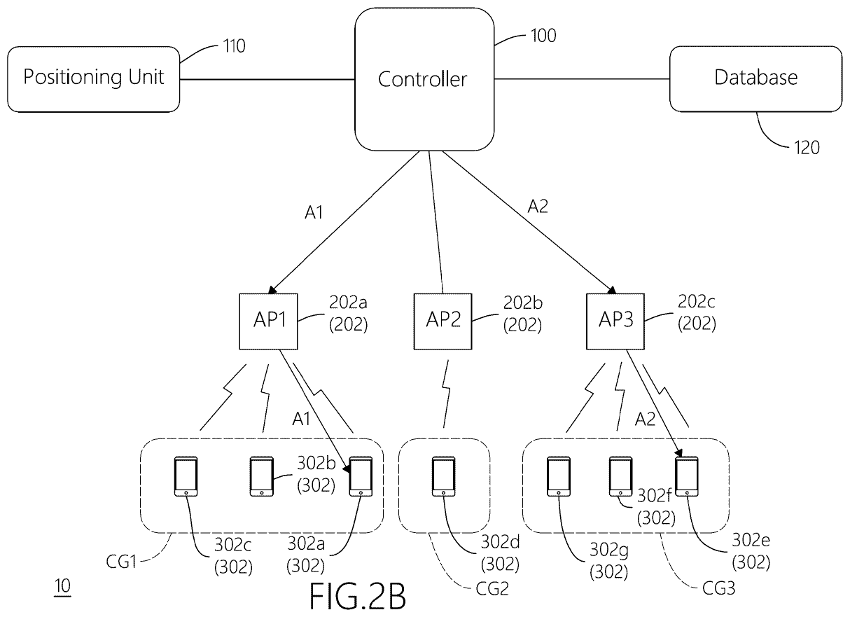

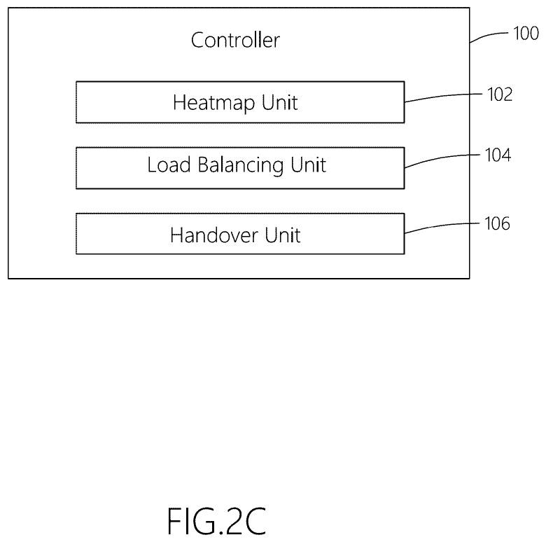

FIGS. 2A and 2B are schematic diagrams of a wireless network system according to one embodiment of the present disclosure. FIG. 2C is a schematic diagram of a controller of the wireless network system shown in FIGS. 2A and 2B. Referring to FIGS. 2A to 2B, the wireless network system 10 comprises a plurality of access points (APs) 202 and a controller 100. The wireless network system 10 may be a wireless local area network (WLAN). In some other embodiments, the wireless network system 10 may be a wireless wide area network (WWAN). The APs 202 shown in FIGS. 2A and 2B may be individually labeled 202a, 202b, and 202c, and may be referred to collectively as the APs 202. Three APs are shown in the wireless network system 10, however, any number of APs 202 may be implemented.

The controller 100 may be a logical entity that implements logic for monitoring and managing the APs 202 in the wireless network system 10. The controller 100 may include or may be part of a WLAN controller, mobility controller, wireless control device, wireless control system, a Software-Defined Networking (SDN) controller, or any other network device operable to perform control functions for the wireless network system 10. In some embodiments, the controller 100 may serve a multifaceted role in the wireless network system 10, for example, providing centralized management and control over the APs for efficiency and reliability of the system. The controller 100 may support any number of APs 202. In some embodiments, the controller 100 may include or may be part of, for example, a server, a personal computer, a laptop computer, a cloud-based device, a virtual device, or the like implemented in any of the computing devices. In some embodiments, the controller 100 may be a standalone device. In some embodiments, the controller 100 may be distributed on two or more of the above-mentioned devices. The controller 100 may include one or more of processors and/or memories that may be communicatively coupled, e.g., via one or more buses, and may operate in conjunction with or otherwise implement a communicating component for communication with the APs 202. The controller 100 may be communicatively connected with the plurality of access points 202, for example, through wired backbone, Ethernet cable, server, router, and/or related devices, or in some embodiments, through wireless connection.

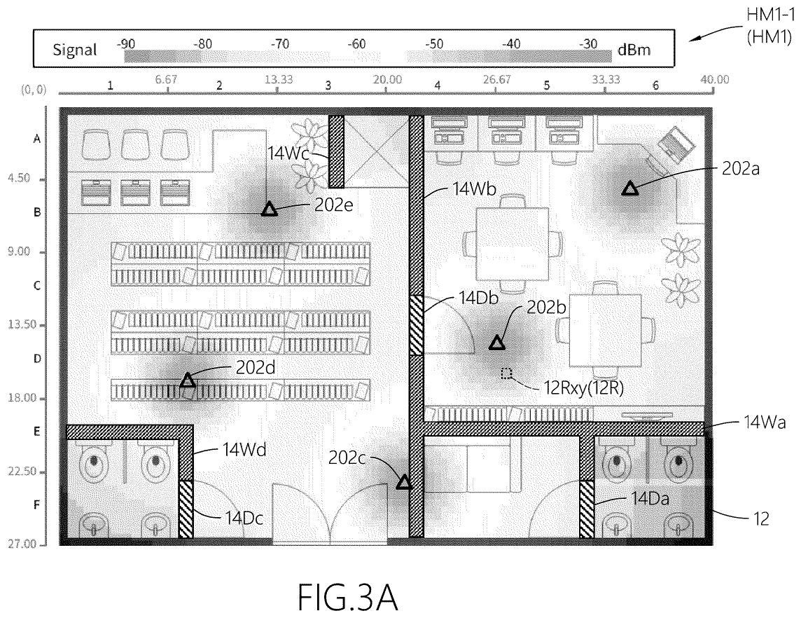

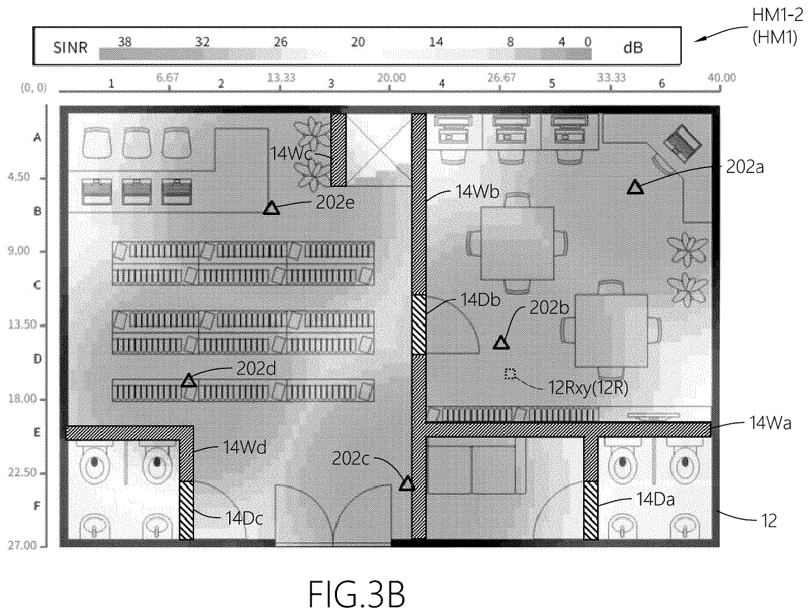

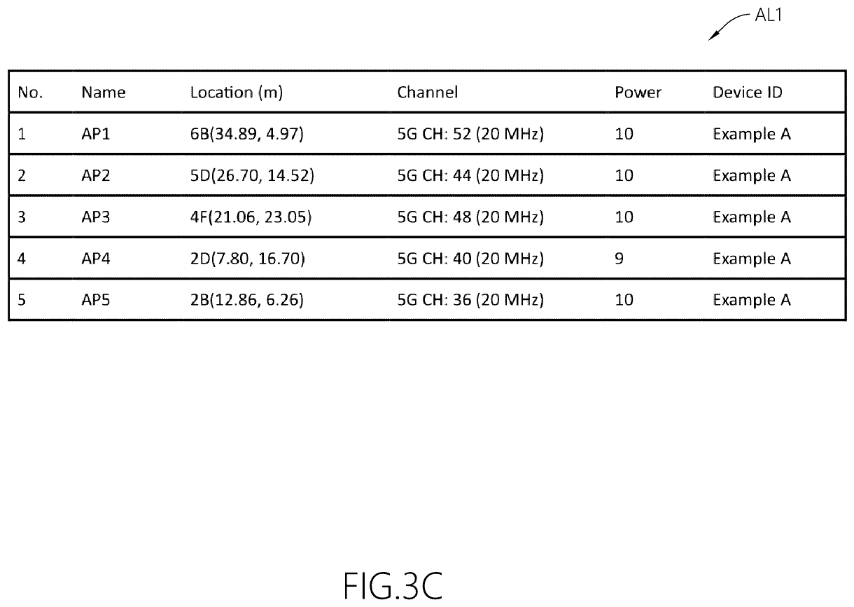

The plurality of access points 202 are configured to provide wireless connection in an area (for example, area 12 shown in FIGS. 3A and 3B as described below in greater detail). The APs 202 can be implemented as APs for one of a variety of wireless communication protocols, such as Wi-Fi APs or cellular base stations. In some embodiments, the APs 202 may be connected directly to a wired local area network. The APs 202 may provide overlapping wireless coverage areas for one or more devices to access the network via the APs 202. In some embodiments, the APs 202 may be used to provide wireless connectivity within a specific area, such as office premises, factory areas, large homes, educational institutions, public spaces, the like, and various kinds of spaces. The APs 202 may be appropriately deployed such that the network substantially covers the entire area. The plurality of APs 202 may use different channels to minimize interference. In some embodiments, the plurality of APs 202 may be interconnected by a network infrastructure using the wired distribution system (DS), such as Ethernet. The plurality of APs 202 may be joined into an extended service set (ESS) and share a service set identifier (SSID). In some embodiments, the APs 202 may be able to implement multiple SSIDs. However, embodiments of the present disclosure are not so limited, the APs 202 can be networked together in various architectures.

The wireless network system 10 may serve one or more client stations 302 within the area. The client stations 302 may be wireless electronic devices, such as laptops, smartphones, tablets, and the like. In FIGS. 2A and 2B, client stations 302a, 302b, 302c, 302d, 302e, 302f, 302g are shown as an example. In some instances, a large plurality of client stations may be served by the wireless network system 10. The client stations 302a to 302g may be collectively referred to herein as the client stations 302. The APs 202 can provide wireless services for communicatively coupling the client stations 302 or providing access to another wide area network (WAN), such as the Internet. In the embodiment shown in FIG. 2A, the client stations 302a, 302b, and 302c are wirelessly connected to the access point 202a, the client station 302d is wirelessly connected to the access point 202b, and the client stations 302e, 302f, and 302g are wirelessly connected to the access point 202c. For simplicity, the client stations 302a, 302b, and 302c may be referred to herein as first plurality of client stations CG1, the client station 302d may be referred to herein as second plurality of client stations CG2, and the client stations 302e, 302f, and 302g may be referred to herein as third plurality of client stations CG3.

As shown in FIG. 2C, the controller 100 may comprise several functional units, such as a heatmap unit 102, a load balancing unit 104, and a handover unit 106. In one embodiment, the heatmap unit 102, the load balancing unit 104, and the handover unit 106 are software components that are implemented in a server or a personal computer. However, one of ordinary skill in the art may appreciate that these software components or units may be implemented elsewhere, depending on various implementation details. For example, the heatmap unit 102, the load balancing unit 104, and the handover unit 106 may be software running in a cloud or may be software modules integrated into other logical entities in the wireless network system 10. In some other embodiments, various software modules may be implemented in various hardware devices.

The heatmap unit 102 is configured to store a heatmap HM1. The heatmap herein includes a set of data representing values of characteristic(s), such as signal strength, frequency, interference, and/or other characteristics of wireless signals (e.g., signals from the plurality of access points 202) received that correspond to a given position or a given subregion. A heatmap may be visualized into one or more figures according to the data it includes by using color to represent the magnitude of the values.

FIGS. 3A and 3B illustrate an exemplary heatmap HM1 according to one embodiment of the present disclosure. In the exemplary heatmap HM1 shown in FIG. 3A, the area 12 is divided into multiple subregions 12R. For example, a subregion 12Rxy shown in FIG. 3A can be indicated by coordinate values thereof. In the present embodiment, the subregions are substantially square shaped. However, embodiments of the present disclosure are not so limited. In some other embodiments, the subregions may be of other shapes or may be irregular shaped. In some embodiments, each of the subregions may be of an area from about 1 square meters to about 9 square meters. In some embodiments, each of the subregions may be of an area smaller than about 1 square meters. However, embodiments of the present disclosure are not so limited. Suitable size of the subregions may be adopted depending on application and requirement. In the embodiment shown in FIG. 3A, the area 12 is equipped with walls, such as partition walls 14Wa, 14Wb, 14Wc, and 14Wd and doors 14Da, 14Db, and 14Dc. A plurality of access points 202a, 202b, 202c, 202d, and 202e are disposed within the area 12. FIG. 3C illustrates an access point list ALL for the heatmap HM1. An access point list may list properties of the access points, such as name, location, MAC address, SSID, height, antenna type, angle of orientation, channel, and power. The access point list AL1 shown in FIG. 3C lists names, locations, channels, powers, and SSID of the access points 202a, 202b, 202c, 202d, and 202e.

The heatmap HM1 may represent values of signal strength, e.g., signal strength indicators (RSSIs), of the wireless signals received from the plurality of access points 202a, 202b, 202c, 202d, and 202e within the area 12. The visualized figure HM1-1 of the heatmap HM1 shown in FIG. 3A displays received RSSIs of wireless signals from the plurality of access points 202a, 202b, 202c, 202d, and 202e received in each of the subregions 12R within the area 12. The heatmap may be shown corresponding to a floor layout of the area 12. For example, in FIG. 3A, partition walls 14Wa, 14Wb, 14Wc, and 14Wd and doors 14Da, 14Db, and 14Dc are shown. However, embodiments of the present disclosure are not so limited.

The heatmap HM1 may also represent values of interference, such as signal-to-interference-plus-noise ratios (SINRs), of the wireless signals received from the plurality of access points 202a, 202b, 202c, 202d, and 202e within the area 12. As shown in FIG. 3B, the visualized figure of heatmap HM1-2 of the heatmap HM1 displays SINRs of the signals received from the plurality of access points 202a, 202b, 202c, 202d, and 202e received in each of the subregions 12R within the area 12.

In some embodiments, the heatmap unit 102 may be further configured to generate the heatmap HM1. Specifically, the heatmap unit 102 may be configured to receive area information IAR, such as one or more of area layouts of the area 12 (e.g., layout of office premises, factory areas, homes, public space, etc.), wall information including the disposition and locations of the wall(s) (e.g., the partition walls 14Wa, 14Wb, 14Wc, and 14Wd and doors 14Da, 14Db, and 14Dc shown in FIGS. 3A and 3B) in the area 12, and wall loss information, which may vary by materials and/or thicknesses of the wall(s). For example, in the embodiment shown in FIGS. 3A to 3C, the walls 14Wa, 14Wb, 14Wc, and 14Wd may be categorized as brick walls and may be considered as having a first value of wall attenuation (e.g., 8 dB), and the doors 14Da, 14Db, and 14Dc may be categorized as light doors and may be considered as having a second value of wall attenuation (e.g., 4 dB). Embodiments of the present disclosure may be equipped with various types of walls, such as concrete wall, plasterboard wall, glass wall with metal frame, metal door, thick window, etc., each having a corresponding attenuation value. The heatmap unit 102 may be configured to receive access point information IAP, such as access point location information, access point channel information, access point channel bandwidth information, and/or access point power information of the plurality of access points 202. The heatmap unit 102 may store and/or may be configured to receive path loss model(s). The heatmap unit 102 may store and/or may be configured to receive and/or generate path loss parameters, e.g., parameters corresponding to walls with various materials and thickness with respect to the path loss model(s). The heatmap unit 102 may be configured to generate a heatmap (e.g., the heatmap HM1) based on the above mentioned data, such as the one or more path loss models, path loss parameters, the area information IAR, and the access point information IAP.

In some embodiments, the wireless network system 10 shown in FIGS. 2A to 2C may comprise a database 120 storing the area information IAR, the access point information IAP, the path loss model(s), and/or path loss parameters, and the heatmap unit 102 may receive the area information IAR, the access point information IAP, the path loss model(s), and/or path loss parameters from the database 120. In some embodiments, the heatmap unit 102 may receive the area information IAR, the access point information IAP, the path loss model(s), and/or path loss parameters through an I/O interface and I/O device(s) coupled to the I/O interface.

As an example, a path loss model expressed by the following formula 1 may be adopted by the heatmap unit 102, wherein d is the distance in meters between an access point and the subregion or position at issue, fc is the frequency of signal from that access point in gigahertz, and X is an environment-specific parameter, such as wall attenuation as discussed above:

$$PL = A {log}_{10} ( d ⌊ m ⌋ ) + B + C {log}_{10} ( \frac{{f}_{c} [ GHz ]}{50} ) + X \qquad ( formula 1 )$$

By the aforementioned process, a heatmap representing values of the characteristic(s) (e.g., RSSIs) of signals received from a plurality of access points in each of the subregions and/or a heatmap representing values of the characteristic(s) (e.g., RSSIs) of signals received from each of the access points can be generated. A heatmap representing values of interference (e.g., SINRs) of signals received from a plurality of access points in each of the subregions and/or a heatmap representing values of interference (e.g., SINRs) of signals received from each of the access points can be generated by method(s) similar to that described above. Mathematical models and related parameters may be used. For example, APs being set to the same or overlapping channels may cause interference. In some embodiments, heatmap generated through the aforementioned process may be subject to a subsequent correction calculation(s), for example, based on actual measurement results. In some other embodiments, a heatmap may be generated by a region-by-region measurement, for example, by a measurement process beforehand. For example, the signal strength and/or interference of signals received in each of the subregions may be measured. The heatmap unit 102 may be configured to generate a heatmap through process(es) described above and without extensive data collection by client station(s) during operation time. In some embodiments, the heatmap unit 102 may be configured to generate the heatmap through offline computation and/or data collection, which may be conducted substantially during downtime or system maintenance.

The load balancing unit 104 is configured to monitor loads of the plurality of access points 202. The load balancing unit 104 may be configured to receive load information from the access points 202, e.g., load information IL1, IL2, and IL3 from access points 202a, 202b, and 202c, respectively. In some embodiments, the load balancing unit 104 may be configured to send a status request requesting load information and configured to receive a status response in response to the request. The load information may include throughput (upload throughput, download throughput, and/or total throughput), number of connected client stations, and/or other related information of a specific access point. In some embodiments, the controller 100 may be installed with one or more network management software to receive and show real time load information of the plurality of access points 202.

The load balancing unit 104 may be further configured to determine whether the plurality of access points 202 is overloaded based on the loads of the plurality of access points, e.g., the load information IL1, IL2, and IL3. During operation of the wireless network system 10, the load balancing unit 104 may be configured to constantly receive and analyze the load information. The load balancing unit 104 may be configured to store or be inputted with access point capacity information, e.g., access point capacity information IC1, IC2, and IC3 of access points 202a, 202b, and 202c and determine whether a specific access point of the plurality of access points 202 is overloaded based on the load information IL1, IL2, and IL3 and access point capacity information IC1, IC2, and IC3. In some embodiments, the database 120 may store the access point capacity information IC1, IC2, and IC3, and the load balancing unit 104 may receive the access point capacity information IC1, IC2, and IC3 from the database 120. However, embodiments of the present disclosure are not so limited. The access point capacity information may include maximum number of possible clients, maximum data transfer rate (upload transfer rate, download transfer rate, and/or total transfer rate), and/or other related information of a specific access point. The load balancing unit 104 may be configured to execute a load analysis algorithm to determine whether a specific access point is overloaded. In some instances, the load balancing unit 104 may determine whether the AP radio utilization of a specific access point exceeds a predetermined percentage, e.g., 80 percent or 85 percent. In some instances, the load balancing unit 104 may determine whether the number of clients connected to a specific access point exceeds a predetermined percentage, e.g., 80 percent or 85 percent, of a maximum number of possible clients of the specific access point.

The load balancing unit 104 is configured to select an overloaded access point from the plurality of access points 202 for further load balancing operation. In the embodiment shown in FIGS. 2A and 2B, a first access point (e.g., the access point 202a), which is determined to be overloaded, is selected. In some embodiments, the load balancing unit 104 is configured to generate a list of overloaded access points and select one or more of the overloaded access points from the list for further load balancing operation. The embodiments of the present disclosure are not so limited. In some embodiments, the first access point may be any access point determined to be overloaded.

The load balancing unit 104 may be configured to receive locations of a first plurality of client stations CG1, e.g., client station locations P11, P12, P13 of the client stations 302a, 302b, and 302c, respectively. A location of a client station discussed herein is data representing the physical location of said client station. In some embodiments, a location of a client station may be shown in a form of a set of coordinate values. A location of a client station may be acquired by various method(s), as described below in greater detail, with acceptable errors. In some embodiments, the wireless network system 10 may further comprises a positioning unit 110. The positioning unit 110 may be included in the controller 100 or in other device(s) communicatively connected with the controller 100. The positioning unit 110 is configured to acquire locations of the client stations 302, including the first plurality of client stations CG1.

In some embodiments, one or more of the client stations 302 may be configured to acquire self-positioning information. For example, one or more of the client stations may be equipped with positioning module and/or related sensors, such as inertial navigation system and gyroscopes. For example, one or more of the client stations may be equipped with Global Positioning System (GPS) receivers and may be configured to acquire self-positioning information through GPS service(s). The positioning unit 110 may be configured to acquire locations of the client stations 302 by receiving report of self-positioning information from the client stations 302.

In some embodiments, the positioning unit 110 may include a fingerprint database, which stores fingerprint data (e.g., Wi-Fi fingerprint data), and may be configured to compare a client station's fingerprint with the database to infer location of the client station. In some embodiments, the positioning unit 110 may be configured to acquire the locations using ultra-wideband (UWB) positioning techniques, Wi-Fi positioning techniques, Bluetooth Low Energy (BLE) positioning techniques, LiDAR positioning techniques, the like, or combinations thereof. In some embodiments, the positioning unit 110 may be configured to execute one or more of angle of arrival (AoA) algorithm(s), time-of-arrival-based (ToA-based) algorithm(s), and/or dead reckoning algorithm(s). In some embodiments, one or more signal source(s) and/or receiver(s), such as positioning anchors, may be deployed in the area, such as area 12 shown in FIGS. 3A and 3B. In some embodiments, one or more client stations may be equipped with positioning element, such as tag for signal emission. Embodiments of the present disclosure are not so limited.

The load balancing unit 104 may be configured to receive locations of the first plurality of client stations CG1 from the positioning unit 110. In the embodiment shown in FIG. 2A, the load balancing unit 104 receives locations P11, P12, P13 of the client stations 302a, 302b, 302c from the positioning unit 110. In some embodiments, the load balancing unit 104 may receive a first client list CL1 of the first plurality of client stations CG1, for example, from the first access point 202a, and may send a positioning request to the positioning unit 110 for locations of the client stations on the first client list CL1. The positioning unit 110 may provide locations P11, P12, P13 of each of the client stations 302a, 302b, 302c to the load balancing unit 104 in response to the positioning request.

The load balancing unit 104 may be configured to conduct a handover selection to achieve objective of load balancing. Specifically, the load balancing unit 104 may be configured to select a client station from the first plurality of client stations CG1 and a corresponding access point from the plurality of access points 202 for the client station to handover to. In the embodiment shown in FIGS. 2A to 2B, the first client station 302a and the second access point 202b are selected. The load balancing unit 104 may execute a load balancing algorithm, and the first client station 302a may be determined to be suitable for connection to the second access point 202b by results of the load balancing algorithm. The load balancing unit 104 may execute the load balancing algorithm based on a heatmap (e.g., the heatmap HM1) and locations of the first plurality of client stations (e.g., the locations P11, P12, P13 of the client stations 302a, 302b, and 302c).

In the embodiment where the heatmap HM1 represents values of signal strength of the signals received from the plurality of access points 202, the load balancing unit 104 may be further configured to acquire a plurality of first data sets DS1 from the heatmap HM1 and the locations P11, P12, P13 of the first plurality of client stations 302a, 302b, and 302c, wherein each first data set DS1 represents the values of signal strength of the signals received from the plurality of access points 202 by one of the first plurality of client stations 302a, 302b, and 302c. For example, the load balancing unit 104 may acquire a first data set DS1a (S1a, S2a, S3a, . . . ) of the client station 302a including a signal strength S1a of the signal received from the access point 202a by the client station 302a, a signal strength S2a of the signal received from the access point 202b by the client station 302a, a signal strength S3a of the signal received from the access point 202c by the client station 302a, and so forth. The first data set DS1a may be acquired by referring to data corresponding to location of the client station 302a, which is indicated by location P11 of the client station 302a, in the heatmap HM1. Similarly, the load balancing unit 104 may acquire a first data set DS1b (S1b, S2b, S3b, . . . ) of the client station 302b, a first data set DS1c (S1c, S2c, S3c, . . . ) of the client station 302c, and so forth. As such, the load balancing unit 104 may acquire signal strengths of the signals received, from potential target access points for handover, by each client station of the first plurality of client stations.

In the embodiment where the heatmap HM1 represents values of interference of the signals received from the plurality of access points 202, the load balancing unit 104 may be further configured to acquire a plurality of second data sets DS2 from the heatmap HM1 and the locations P11, P12, P13 of the first plurality of client stations 302a, 302b, and 302c, wherein each second data set DS2 represents the values of interference of the signals received from the plurality of access points 202 by one of the first plurality of client stations 302a, 302b, and 302c. For example, the load balancing unit 104 may acquire a second data set DS2a (I1a, I2a, I3a, . . . ) of the client station 302a including an interference I1a of the signal received from the access point 202a by the client station 302a, an interference I2a of the signal received from the access point 202b by the client station 302a, an interference I3a of the signal received from the access point 202c by the client station 302a, and so forth. The second data set DS2a may be acquired by referring to data corresponding to location of the client station 302a, which is indicated by location P11 of the client station 302a, in the heatmap HM1. Similarly, the load balancing unit 104 may acquire a second data set DS2b (I1b, 12b, I3b, . . . ) of the client station 302b, a second data set DS2c (I1c, I2c, I3c, . . . ) of the client station 302c, and so forth. As such, the load balancing unit 104 may acquire interference of the signals received, from potential target access points for handover, by each client station of the first plurality of client stations.

The load balancing unit 104 may be configured to execute the load balancing algorithm based on the plurality of first data sets DS1a, DS1b, DS1c. In some embodiments, the load balancing unit 104 may be configured to execute the load balancing algorithm based on the plurality of second data sets DS2a, DS2b, DS2c. For example, the load balancing algorithm may determine a client station which is suitable for handover to another access point by one or more of the following handover parameters: load information of the plurality of access points 202, such as load information IL1, IL2, and IL3 as discussed above, access point capacity information of the plurality of access points 202, such as access point capacity information IC1, IC2, and IC3 as discussed above, signal strengths of the signals received from potential target access points for handover by each client station of the first plurality of client stations, which may be represented by the first data sets DS1a, DS1b, DS1c as discussed above, and interference of the signals received from potential target access points for handover by each client station of the first plurality of client stations, which may be represented by the second data sets DS2a, DS2b, DS2c as discussed above. However, embodiments of the present disclosure are not so limited. In some embodiments, the load balancing unit 104 may compare a plurality of possible handover actions based on the handover parameters and select one or more suitable option(s) among them, wherein each of the possible handover actions includes one client station from the first plurality of client stations and a target access point (e.g., a nearby access point). In the embodiment shown in FIGS. 2A to 2B, a first client station (the client station 302a) and a second access point (the access point 202b) are selected.

The handover unit 106 may be configured to transmit a handover message according to the handover selection. As shown in FIG. 2B, the handover unit 106 is configured to transmit a first handover message A1 to the first client station 302a through the first access point 202a for performing a handover of the first client station 302a from the first access point 202a to the second access point 202b. In some embodiments, the handover message A1 can be a trigger advising the first client station 302a to roam from one access point (e.g., the first access point 202a) to another access point (e.g., the second access point 202b). The first client station 302a may accordingly initiate an authentication frame exchange with the second access point 202b and may start the association process in order to connect to the second access point 202b. However, embodiments of the present disclosure are not so limited.

As shown in FIG. 2B, another handover operation may be made through similar process as discussed above, for example, with respect to another access point (e.g., the access point 202c). The handover unit 106 may select a client station (e.g., the client station 302e) from the third plurality of client stations CG3 connected to the access point 202c and a corresponding access point (e.g., the access point 202b) from the plurality of access points 202. The handover unit 106 may be configured to transmit a second handover message A2 to the client station 302e through the third access point 202c for performing a handover of the client station 302e from the access point 202c to the access point 202b. The second handover message A2 may function similarly as the first handover message A1. The handover operation described in this paragraph may be performed before, after, or at the same time as the above described handover operation.

The wireless network system discussed above may enable a load balancing control in a timely manner while maintaining the quality of the connection. For example, the handover decision can be made base on an existing and readily available heatmap, generation of which may be done without extensive data collection by client station(s) during operation time. As such, the wireless network system may enable a higher transmission rate, since the channel scanning of client station is unnecessary. Also, consumption of resources from client station can be avoided. Moreover, the wireless network system may achieve better handover decision due to a more comprehensive information made available by the heatmap.

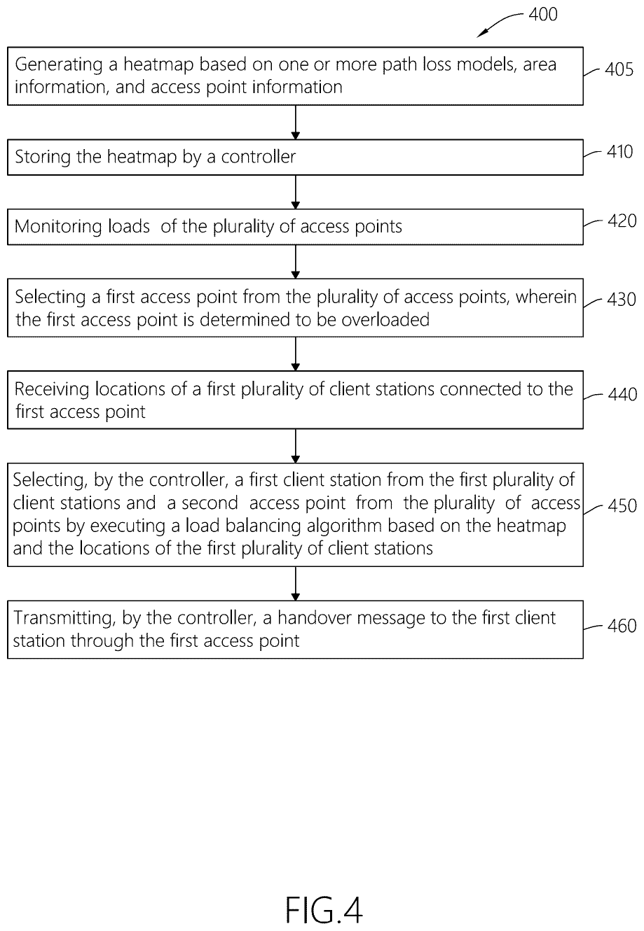

FIG. 4 is a flowchart illustrating a method for load balancing control of wireless connection in an area 12 according to one embodiment of the present disclosure. The method 400 of FIG. 4 may be applied to the wireless network system 10 of FIG. 2A. The method 400 may include the following steps.

At step 405, the controller 100 (e.g., the heatmap unit 102 of the controller 100) may generate a heatmap HM1 based on one or more path loss models, area information IAR, and access point information IAP. Heatmap represents values of at least one characteristic of signals received from the plurality of access points in subregions within the area, wherein the at least one characteristic of signals includes at least one of signal strength, frequency, and interference. The area information IAR may include one or more of area layouts, wall information, and wall loss information of the area 12. The access point information IAP may include access point location information, access point channel information, access point channel bandwidth information, and/or access point power information of the plurality of access points 202. The heatmap HM1 may be generated without extensive data collection by client station(s) during operation time. In some embodiments, the heatmap HM1 may be generated without data collected by the plurality of client stations 302. In some embodiments, the heatmap HM1 may be generated through offline computation or data collection, which may be conducted substantially during downtime or system maintenance. However, embodiments of the present disclosure are not so limited. In some embodiments, a heatmap may be generated by any one or more computing device(s). In some embodiments, a heatmap may be generated by a measurement process beforehand, for example, during downtime or system maintenance.

At step 410, the controller 100 (e.g., the heatmap unit 102 of the controller 100) may store a heatmap, such as the heatmap HM1 as discussed above. The method disclosed herein may facilitate generation of a heatmap with a more comprehensive information. In some embodiments, the heatmap may represent values of the at least one characteristic of signals received in each of the subregions within the area 12. In some embodiments, the heatmap may represent values of the at least one characteristic of signals received from each of the plurality of access points. As such, a more timely and/or more accurate handover operation may be performed.

At step 420, the controller 100 (e.g., the load balancing unit 104 of the controller 100) may monitor loads of the plurality of access points 202. The controller 100 may receive load information of the access points 202, e.g., load information IL1, IL2, and IL3 of access points 202a, 202b, and 202c, which may be real-time load information. However, embodiments of the present disclosure are not so limited. In some embodiments, loads of the plurality of access points may be monitored by any one or more monitoring and/or controlling device(s) and/or module(s).

At step 430, the controller 100 (e.g., the load balancing unit 104 of the controller 100) may select a first access point, which is determined to be overloaded, from the plurality of access points 202. In some embodiments, the controller 100 may determine whether one of the plurality of access points is overloaded based on the load information and capacity information of the plurality of access points 202. The controller 100 may start a handover operation if at least one of the access points is determined to be overloaded. The controller 100 may select the first access point based on the load information and capacity information of the plurality of access points 202, or may designate any one of the access point determined to be overloaded as the first access point.

At step 440, the controller 100 (e.g., the load balancing unit 104 of the controller 100) may receive locations of a first plurality of client stations connected to the first access point. In some embodiments, the controller 100 may receive a list of the first plurality of client stations in advance and may request for locations based on the list. The controller 100 may receive the locations of the first plurality of client stations from a positioning unit 110.

In some embodiments, the positioning unit 110 may acquire the locations of the first plurality of client stations using ultra-wideband (UWB) positioning techniques, Wi-Fi positioning techniques, Bluetooth Low Energy (BLE) positioning techniques, and/or LiDAR positioning techniques. In some embodiments, one of the first plurality of client stations may be equipped with positioning sensor, such as gyroscopes, GPS receivers, and/or the like. The positioning unit 110 may acquire the location of the client station by receiving report of location from the client station. In some embodiments, the positioning unit 110 may receive fingerprint information of one of the first plurality of client stations and may acquire the location of the client station by comparing the fingerprint information of the client station to data in a fingerprint database. The positioning unit 110 may acquire the locations of the first plurality of client stations by the same or different positioning techniques.

At step 450, the controller 100 (e.g., the load balancing unit 104 of the controller 100) may select a first client station from the first plurality of client stations and a second access point from the plurality of access points by executing a load balancing algorithm based on the heatmap and the locations of the first plurality of client stations.

In the embodiments where the heatmap represents values of signal strength of the signals received from the plurality of access points, the controller 100 may acquire a plurality of first data sets from the heatmap and the locations of the first plurality of client stations. Each of the first data sets represents values of signal strength of the signals received from the plurality of access points by one of the first plurality of client stations. The controller 100 may then execute the load balancing algorithm based on the plurality of first data sets.

In the embodiments where the heatmap represents values of interference of the signals received from the plurality of access points, the controller 100 may acquire a plurality of second data sets from the heatmap and the locations of the first plurality of client stations. Each of the second data sets represents values of interference of the signals received from the plurality of access points by one of the first plurality of client stations. The controller 100 may then execute the load balancing algorithm based on the plurality of second data sets.

In some embodiments, the controller 100 may select the first client station and the second access point by executing the load balancing algorithm further based on the loads of the plurality of access points in addition to the heatmap and the locations of the first plurality of client stations.

At step 460, the controller 100 (e.g., the handover unit 106 of the controller 100) may transmit a handover message to the first client station through the first access point.

In some embodiments, a hardware module that performs a particular function can include a software component stored in a computer-readable medium in connection with the necessary hardware components, such as a processor, a bus, an output device, and so forth, to carry out the method.

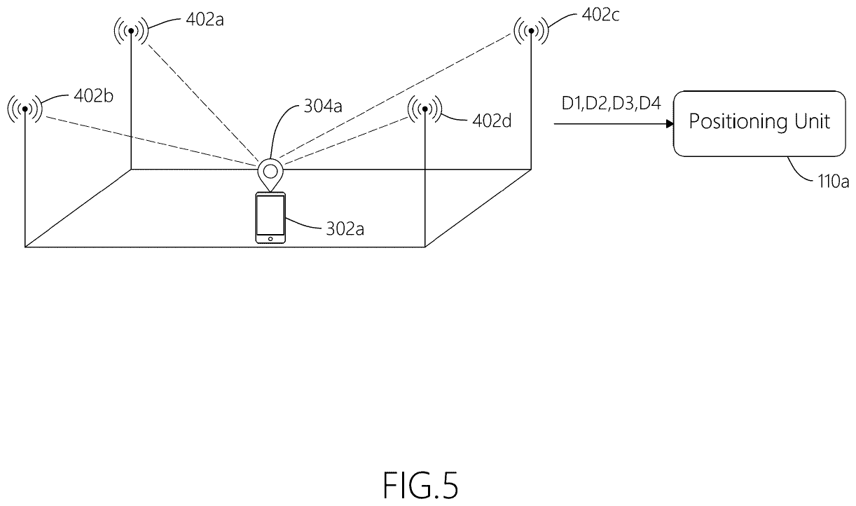

FIG. 5 is a schematic diagram of a positioning unit according to one embodiment of the present disclosure. The positioning unit 110a shown in FIG. 5 may be configured to acquire locations of the client stations using UWB positioning techniques. As shown in FIG. 5, a plurality of positioning anchors, such as positioning anchors 402a, 402b, 402c, 402d with known coordinates may be deployed in the area. One or more client stations, for example, the client station 302a, is equipped with or attached by a UWB tag (e.g., a UWB tag 304a). The UWB tag 304a may be a UWB radio emitter and/or transceiver. In some embodiments, the UWB tag 304a emits pulses containing data (e.g., ID, timestamp data), and nearby positioning anchors, such as positioning anchors 402a, 402b, 402c, 402d, may detect the signal data. However, embodiments of the present disclosure are not so limited. In some embodiments, each of the positioning anchors 402a, 402b, 402c, 402d emits signals, and the UWB tag 304a may detect and response with acknowledgment signal. The positioning unit 110a processes the data (e.g., data D1, D2, D3, D4 related to the positioning anchors 402a, 402b, 402c, 402d, respectively) based on, for example, time-of-arrival techniques and/or other applicable algorithms to determine the coordinates of the client station.

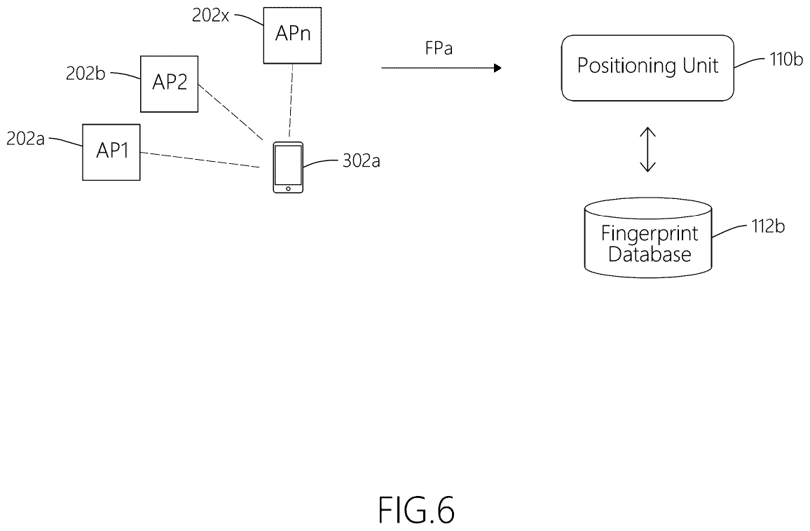

FIG. 6 is a schematic diagram of another positioning unit according to one embodiment of the present disclosure. The positioning unit 110b shown in FIG. 6 may be configured to acquire locations of the client stations using Wi-Fi positioning techniques. The positioning unit 110b may be communicatively connected with a fingerprint database 112b. However, in some embodiments, the fingerprint database 112b may be stored within the positioning unit 110b. The fingerprint database 112b may record locations and signal strengths of surrounding APs of each locations and may be built through site survey or training beforehand. As shown in FIG. 6, a client station, e.g., client station 302a may collect and send fingerprint information FPa to the positioning unit 110b. The fingerprint information may be a set of signal parameters, such as signal strengths of surrounding APs. For example, fingerprint information FPa of client station 302a may include a signal strength from the access point 202a, a signal strength from the access point 202b, and so forth. However, embodiments of the present disclosure are not so limited. The positioning unit 110b may compare the fingerprint information FPa of the client station 302a to data in the fingerprint database 112b to determine the location of the client station, for example, by finding the most similar record in the database.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded the widest scope consistent with the principles and novel features disclosed herein. It is contemplated that additional embodiments are within the spirit and true scope of the disclosed subject matter. Thus, it is intended that the present disclosure covers modifications and variations that come within the scope of the appended claims and their equivalents.

What is claimed is:

1. A method for load balancing control of wireless connection in an area provided by a plurality of access points, the method comprising:
storing, by a controller, a heatmap representing values of at least one characteristic of signals received from the plurality of access points in subregions within the area;
monitoring loads of the plurality of access points;
selecting a first access point from the plurality of access points, wherein the first access point is determined to be overloaded;
receiving locations of a first plurality of client stations connected to the first access point;
selecting, by the controller, a first client station from the first plurality of client stations and a second access point from the plurality of access points by executing a load balancing algorithm based on the heatmap and the locations of the first plurality of client stations; and
transmitting, by the controller, a handover message to the first client station through the first access point.

2. The method of claim 1, wherein the at least one characteristic of signals includes at least one of signal strength, frequency, and interference.

3. The method of claim 1 further comprising generating the heatmap based on one or more path loss models, area information, and access point information.

4. The method of claim 3, wherein the area information includes one or more of area layouts, wall information, and wall loss information of the area.

5. The method of claim 3, wherein the access point information includes access point location information, access point channel information, access point channel bandwidth information, or access point power information of one or more of the plurality of access points.

6. The method of claim 1, wherein the heatmap represents the values of the at least one characteristic of signals received from the plurality of access points in each of the subregions within the area.

7. The method of claim 1, wherein the heatmap represents values of signal strength of the signals received from the plurality of access points, and the selecting the first client station and the second access point comprises acquiring, from the heatmap and the locations of the first plurality of client stations, a plurality of first data sets each representing values of signal strength of the signals received from the plurality of access points by one of the first plurality of client stations and executing the load balancing algorithm based on the plurality of first data sets.

8. The method of claim 1, wherein the heatmap represents values of interference of the signals received from the plurality of access points, and the selecting the first client station and the second access point further comprises acquiring, from the heatmap and the locations of the first plurality of client stations, a plurality of second data sets each representing values of interference of the signals received from the plurality of access points by one of the first plurality of client stations and executing the load balancing algorithm based on the plurality of second data sets.

9. The method of claim 1, wherein selecting the first client station and the second access point by executing the load balancing algorithm further based on the loads of the plurality of access points.

10. The method of claim 1, wherein the receiving the locations of the first plurality of client stations comprises receiving the locations of the first plurality of client stations from a positioning unit.

11. The method of claim 10 further comprising acquiring the locations of the first plurality of client stations by the positioning unit using ultra-wideband (UWB) positioning techniques, Wi-Fi positioning techniques, Bluetooth Low Energy (BLE) positioning techniques, or LiDAR positioning techniques.

12. A wireless network system, comprising:
a plurality of access points configured to provide wireless connection in an area; and
a controller communicatively connected with the plurality of access points, the controller comprising:
a heatmap unit configured to store a heatmap representing values of at least one characteristic of signals received from the plurality of access points in subregions within the area;
a load balancing unit configured to:
monitor loads of the plurality of access points;
select a first access point from the plurality of access points, wherein the first access point is determined to be overloaded;
receive locations of a first plurality of client stations connected to the first access point; and
select a first client station from the first plurality of client stations and a second access point from the plurality of access points by executing a load balancing algorithm based on the heatmap and the locations of the first plurality of client stations; and
a handover unit configured to transmit a handover message to the first client station through the first access point.

13. The wireless network system of claim 12, wherein the at least one characteristic of signals includes at least one of signal strength, frequency, and interference.

14. The wireless network system of claim 12 further comprising a positioning unit configured to acquire the locations of the first plurality of client stations, and wherein the load balancing unit receives the locations of the first plurality of client stations from the positioning unit.

15. The wireless network system of claim 12, wherein the heatmap unit is configured to receive area information and access point information and generate the heatmap based on one or more path loss models, the area information, and the access point information.

16. The wireless network system of claim 12, wherein the heatmap represents the values of the at least one characteristic of signals received from the plurality of access points in each of the subregions within the area.

17. The wireless network system of claim 12, wherein the load balancing unit is configured to determine whether the plurality of access points is overloaded based on the loads of the plurality of access points.

18. A computer-readable medium storing computer executable code for load balancing control of wireless connection in an area provided by a plurality of access points, the code when executed by a processor of a controller cause the processor to:
store a heatmap representing values of at least one characteristic of signals received from the plurality of access points in subregions within the area;
monitor loads of the plurality of access points;
select a first access point from the plurality of access points, wherein the first access point is determined to be overloaded;
receive locations of a first plurality of client stations connected to the first access point;
select a first client station from the first plurality of client stations and a second access point from the plurality of access points by conducting a load balancing algorithm based on the heatmap and the locations of the first plurality of client stations;
transmit a handover message to the first client station through the first access point.

19. The computer-readable medium of claim 18, wherein the code when executed by a processor cause the processor to generate the heatmap based on one or more path loss models, area information, and access point information.
